(19) United States
(12) Patent Application Publication
(10) Pub. No.: US 2023/0324515 A1
(43) Pub. Date: Oct. 12, 2023

(54) AUTONOMOUS MOBILE DEVICE

(71) Applicant: Qfeeltech (Beijing) Co., Ltd., Beijing (CN)

(72) Inventors: Xingguo XING, Beijing (CN); Xin WU, Beijing (CN)

(21) Appl. No.: 18/334,581

(22) Filed: Jun. 14, 2023

Related U.S. Application Data
(63) Continuation of application No. PCT/CN2021/129467, filed on Nov. 9, 2021.

(30) Foreign Application Priority Data
Dec. 15, 2020 (CN) 202011481953.6

(51) Int. Cl. G01S 7/481; G05D 1/02

(52) U.S. Cl. CPC G01S 7/4813; G05D 1/0227

(57) ABSTRACT

An autonomous mobile device is provided. The autonomous mobile device includes a main body, a protruding element disposed at a top portion of the main body, and a protection cover disposed at an outer side of the protruding element to cover the protruding element, the protection cover being movably connected with the main body or the protruding element. The autonomous mobile device also includes a detecting device configured to detect an external force exerted on the protection cover or a displacement of the protection cover caused by the external force, and to transmit information of the external force or the displacement to a processor. The autonomous mobile device also includes a position restoring assembly, the processor, and an extension-retraction groove disposed on the main body at a circumference of a lower portion of the protruding element. The protection cover is inserted into the extension-retraction groove.

### CROSS-REFERENCE TO RELATED APPLICATIONS

This application is a continuation of International Application No. PCT/CN2021/129467, filed on Nov. 9, 2021, which claims priority to Chinese Patent Application No. 202011481953.6, filed on Dec. 15, 2020, in Chinese Patent Office, and titled “Autonomous Mobile Device.” The entire content of the above-mentioned applications is incorporated herein by reference.

### TECHNICAL FIELD

The present disclosure generally relates to the technical field of smart home and, more specifically, to an autonomous mobile device.

### BACKGROUND

As technologies advance and life quality increases, autonomous mobile devices equipped with different functions (e.g., floor sweeping robots, mover robots, etc.) have been gradually implemented in industrial productions and people's daily life.

An autonomous mobile device typically includes a main body, a motion device, and a light detection and ranging (“Lidar”) device. The motion device is disposed at a bottom of the main body, and is in contact with the floor to cause the main body to move on the floor and make turns. The Lidar device is disposed on the top of the main body. The Lidar device is configured to detect a distance between the Lidar device and surrounding objects. The Lidar device provides distance or location information of the objects in the environment for the localization and mapping of the autonomous mobile device.

However, the Lidar device is typically disposed in a protruding element at the top of the main body. During movement, because the Lidar device is higher than the main body, it is easy for the Lidar device to collide with an external object, causing damages to the Lidar device.

### SUMMARY OF THE DISCLOSURE

The present disclosure provides an autonomous mobile device configured to solve the issue relating to the Lidar device being disposed at the top of the main body, and the Lidar device being easy to collide with the external objects during movement, causing damages to the Lidar device.

The autonomous mobile device provided by embodiments of the present disclosure includes a main body, a protruding element, a protection cover, a detecting device, a position restoring assembly, and a processor. The protruding element is disposed at a top portion of the main body. The protection cover is disposed at an outer side of the protruding element to cover the protruding element. The protection cover is movably connected with the main body or the protruding element. The detecting device is configured to detect an external force exerted on the protection cover or a displacement of the protection cover caused by the external force, and to transmit information of the external force exerted on the protection cover or information of the displacement to the processor. An extension-retraction groove is disposed on the main body at a circumference of a lower side of the protruding element. The protection cover is inserted into the extension-retraction groove. Two ends of the position restoring assembly are connected with the protection cover and a groove bottom of the extension-retraction groove, respectively. After the protection cover experiences a displacement of the protection cover caused by the external force and after the external force is released, the position restoring assembly is configured to restore the protection cover to a position where the protection cover is free from the external force. A first end of the detecting device is connected with the groove bottom of the extension-retraction groove. A second end of the detecting device can contact the protection cover when the protection cover is subject to the external force or when the protection cover experiences a displacement of the protection cover caused by the external force.

A positive moving direction may be defined for the autonomous mobile device. A front end of the protection cover along the positive moving direction is connected with the main body or the protruding element, such that the protection cover can perform upward and downward rotations around the front end of the protection cover, and a rotation axis of the upward and downward rotations is parallel with a horizontal plane and perpendicular to the positive moving direction. The detecting device includes a first detecting device. The position restoring assembly includes a first position restoring assembly. A first end of the first position restoring assembly is connected with a groove bottom at a back end of the extension-retraction groove along the positive moving direction. A second end of the first position restoring assembly is connected with a lower portion of a back end of the protection cover along the positive moving direction. A first end of the first detecting device is connected with the groove bottom at the back end of the extension-retraction groove along the positive moving direction. A second end of the first detecting device can contact the lower portion of the back end of the protection cover along the positive moving direction when the protection cover rotates downwardly.

In some embodiments, the detecting device also includes a second detecting device. The position restoring assembly includes a second position restoring assembly. A first end of the second position restoring assembly is connected with the groove bottom at a front end of the extension-retraction groove along the positive moving direction. A second end of the second position restoring assembly is connected with the lower portion of the front end of the protection cover along the positive moving direction. A first end of the second detecting device is connected with the groove bottom at the front end of the extension-retraction groove along the positive moving direction. A second end of the second detecting device can contact the lower portion of the front end of the protection cover along the positive moving direction when the protection cover rotates downwardly.

In some embodiments, when the back end of the protection cover along the positive moving direction is subject to a downward pressing force that is perpendicular to a top portion of the protection cover, or when the front end of the protection cover along the positive moving direction is subject to a force in a direction opposite to the positive moving direction, the protection cover compresses the first position restoring assembly and contacts the first detecting device; and/or, when the front end of the protection cover along the positive moving direction is subject to a force that is perpendicular to the top portion of the protection cover, the protection cover compresses the second position restoring assembly and contacts the second detecting device.

In some embodiments, the protection cover is movably disposed in the extension-retraction groove along a direction that is substantially perpendicular to the positive moving direction of the main body. A first position restricting ring is disposed at a location of the protection cover facing the groove bottom of the extension-retraction groove. A second position restricting ring is disposed at a side wall of the extension-retraction groove. The second position restricting ring is configured to block the first position restricting ring from moving outside of the extension-retraction groove.

In some embodiments, there are multiple position restoring assemblies. The multiple position restoring assemblies are disposed at intervals from one another around a central axis of the extension-retraction groove. Each position restoring assembly is disposed inside the extension-retraction groove. An end of each position restoring assembly is connected with the first position restricting ring.

In some embodiments, the autonomous mobile device also includes an elevation device. The main body includes a frame and a fixing part. An elevation channel is provided within the frame. The fixing part is slidably disposed in the elevation channel. The protruding element and the protection cover are both disposed on the fixing part. The elevation device is connected with both of the frame and the fixing part. The elevation device is configured to control the fixing part to retract into the elevation channel when the detecting device detects a collision to the protection cover, such that the protection cover and the protruding element retract into the elevation channel.

In some embodiments, the elevation device includes a rotation device, a driving pinion and a rack. The rack is connected with the fixing part. The driving pinion is transmissively connected with the rotation device. The driving pinion and the rack are engaged.

In some embodiments, the elevation device also includes an encoder and a deceleration box. The rotation device includes an electric motor. A main shaft of the electric motor is transmissively connected with an input end of the deceleration box. The driving pinion is transmissively connected with an output end of the deceleration box. The encoder is configured to detect a rotation angle of the main shaft of the electric motor.

In some embodiments, the elevation device includes a driving nut, a driving screw, and the rotation device. The driving nut is connected with the fixing part. The driving screw is rotatably connected with the frame. The driving nut and the driving screw are engaged with one another. The rotation device is transmissively connected with the driving screw.

In some embodiments, the autonomous mobile device also includes a detecting apparatus. The detecting apparatus is configured to detect a position of the fixing part in the elevation channel.

In some embodiments, the detecting apparatus includes a photoelectric sensor or a micro-motion sensor disposed at a bottom of the elevation channel.

The autonomous mobile device provided by the embodiments of the present disclosure includes a protruding element disposed at a top portion of the main body, a protection cover disposed at an outer side of the protruding element to cover the protruding element. The protection cover is movably connected with the main body or the protruding element. The autonomous mobile device also includes a detecting device configured to detect an external force exerted on the protection cover or a displacement of the protection cover caused by the external force, and to transmit information of the external force exerted on the protection cover or information of the displacement to a processor. As such, the protection cover disposed at the outer side of the protruding element that covers the protruding element can protect the protruding element from collision, thereby reducing the chance of damaging the protruding element. Furthermore, the protection cover is movably connected with the main body or the protruding element, and can move when the protection cover is subject to the external force. This configuration enables the detecting device to detect whether a collision occurs to the protection cover through detecting the displacement of the protection cover. As a result, the autonomous mobile device can take a next action based on the detecting result, making the autonomous mobile device more intelligent. Moreover, the autonomous mobile device includes a position restoring assembly. After the protection cover experiences a displacement caused by the external force and after the external force is released, the position restoring assembly is configured to restore the protection cover to a position where the protection cover is free from the external force. Thus, after the external force is withdrawn from the protection cover, a reserved gap between the protection cover and the protruding element is maintained. The detecting device is no longer triggered, and in the meantime is ready for next detection.

### BRIEF DESCRIPTION OF THE DRAWINGS

In order to more clearly describe the technical solutions of the present disclosure or the existing technology, the drawings referred to in the descriptions of the embodiments or the existing technology are briefly introduced below. It is understood that the drawings described below are some embodiments of the present disclosure. A person having ordinary skills in the art can obtain other drawings based on these drawings without spending creative effort.

FIG. 1 is a schematic illustration of an initial state of an autonomous mobile device according to a first embodiment of the present disclosure;

FIG. 2 is a first schematic illustration of the autonomous mobile device provided by the first embodiment shown in FIG. 1;

FIG. 3 is a second schematic illustration of the autonomous mobile device provided by the first embodiment shown in FIG. 1;

FIG. 4 is a schematic illustration of an initial state of an autonomous mobile device according to a second embodiment of the present disclosure;

FIG. 5 is a first schematic illustration of the autonomous mobile device provided by the second embodiment shown in FIG. 4;

FIG. 6 is a second schematic illustration of the autonomous mobile device provided by the second embodiment shown in FIG. 4;

FIG. 7 is a third schematic illustration of the autonomous mobile device provided by the second embodiment shown in FIG. 4;

FIG. 8 is a schematic illustration of an initial state of an autonomous mobile device according to a third embodiment of the present disclosure;

FIG. 9 is a first schematic illustration of the autonomous mobile device provided by the third embodiment shown in FIG. 8;

FIG. 10 is a second schematic illustration of the autonomous mobile device provided by the third embodiment shown in FIG. 8;

FIG. 11 is a schematic illustration of an initial state of an autonomous mobile device according to a fourth embodiment of the present disclosure;

FIG. 12 is a schematic illustration of the autonomous mobile device shown in FIG. 11 when a protruding element is retracted;

FIG. 13 is a schematic illustration of an initial state of another autonomous mobile device according to the fourth embodiment of the present disclosure; and

FIG. 14 is a schematic illustration of the autonomous mobile device shown in FIG. 13 when a protruding element is retracted.

### LABELS FOR ACCOMPANYING DRAWINGS

5—autonomous mobile device; 10—main body; 11—first position restricting ring; 12— fixing part; 17—rotation axis; 19—processor; 20—protruding element; 30—protection cover; 31—slanted surface; 32—second position restricting ring; 41—first detecting device; 42— second detecting device; 51—first position restoring assembly; 52—second position restoring assembly; 60—extension-retraction groove; 70—elevation device; 71—driving nut; 72—driving screw; 73—rotation device; 74—driving pinion; 75—rack; 80—detecting apparatus; 95— elevation channel; 98—frame.

### DETAILED DESCRIPTION

In order to clearly present the objective, technical solution, and advantage of the present disclosure, next, the technical solutions of the present disclosure will be clearly and comprehensively described with reference to the drawings. It is understood that the described embodiments are merely some embodiments of the present disclosure, and are not all of the embodiments. Based on the described embodiments of the present disclosure, a person having ordinary skills in the art can derive other embodiments without spending creative effort. Such derived embodiments also fall within the scope of the present disclosure. When there is no conflict, the embodiments and the features of the embodiments described below can be combined.

In the embodiments of the present disclosure, unless otherwise noted, terms such as “mount,” “connect,” “couple,” “fix,” should be interpreted broadly. For example, such a term can encompass fixed connection, removable/detachable connection, integrated connection, mechanical connection, electrical connection or communicative connection. The connection can be direct connection, or indirect connection through an intermediate medium. Such a term can describe internal connections between two elements or mutual interaction relationship between the two elements, unless otherwise noted. A person having ordinary skills in the art can understand the specific meaning of such a term in this disclosure based on specific context and descriptions.

The term “processor” or “processing device” used herein may encompass any suitable processor, such as a central processing unit (“CPU”), a graphics processing unit (“GPU”), an application-specific integrated circuit (“ASIC”), a programmable logic device (“PLD”), or a combination thereof. Other processors not listed above may also be used. A processor may be implemented as software, hardware, firmware, or a combination thereof.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

A hollow-lower-portion type obstacle is an obstacle, a lower portion of which forms a space with a floor. The space or channel can allow an object of a specific height to enter. For example, the hollow-lower-portion type obstacle may be furniture or home appliances such as a bed, a table, a cabinet, a sofa, which has relatively long legs and which has a lower portion forming a space with the floor.

An autonomous mobile device refers to a smart device configured to autonomously execute predetermined tasks within a predetermined zone. In the present disclosure, autonomous mobile devices include, but are not limited to, cleaning robots (e.g., smart floor sweeping devices, smart floor mopping devices, window cleaning robots, etc.), companion type mobile robots (e.g., smart electronic pets, nanny robots, etc.), service type mobile robots (e.g., reception robots for restaurants, hotels, meeting places), industrial inspection smart devices (e.g., power line inspection robots, smart forklifts, etc.), security robots (e.g., home use or commercial use smart guard robots), etc.

Some autonomous mobile devices are equipped with a Lidar device. The Lidar device can scan the surrounding environment, thereby providing distance or location information for mapping and localization. The Lidar device is typically disposed in a protruding element at a top portion of a main body of the autonomous mobile device, in order to obtain the best scanning and distance measuring performance.

Because the Lidar device is disposed in the protruding element higher than the main body of the autonomous mobile device, when the autonomous mobile device passes the hollow-lower-portion type obstacle, in some conditions, a collision sensor disposed at a lower portion of the main body may indicate that the autonomous mobile device can pass the space under the hollow-lower portion type obstacle, but the protruding element at the top of the main body may collide with the obstacle, which may cause the Lidar device to collide with the hollow-lower-portion type obstacle. The collision may cause damage to the Lidar device or may cause the autonomous mobile device to be jammed by the hollow-lower-portion type obstacle.

As such, embodiments of the present disclosure provide an autonomous mobile device. A protection cover is provided at an outer side of the Lidar device to cover the Lidar device. In addition, when the protection cover experiences a collision, a detecting device may detect the external force exerted on the protection cover or a displacement experienced by the protection cover caused by the collision, thereby enabling the autonomous mobile device to sense the collision. After sensing the collision, the autonomous mobile device may stop moving forward, take predicament avoidance measurements, and/or generate an alarm, etc. The configuration disclosed herein may reduce the chance of damaging the Lidar device, and avoid jamming of the autonomous mobile device.

Next, the autonomous mobile device provided by the embodiments of the present disclosure is explained in detail using the smart cleaning robot as an example of the autonomous mobile device, and with reference to the accompanying drawings.

### First Embodiment

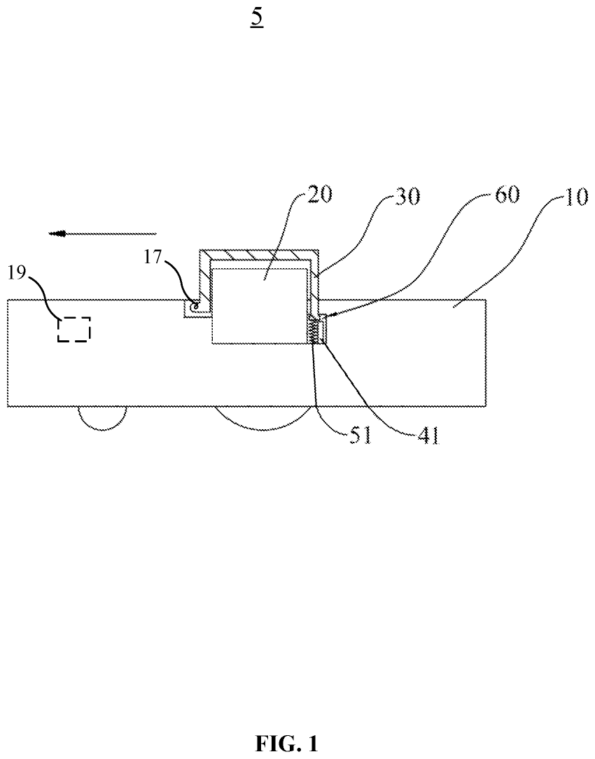

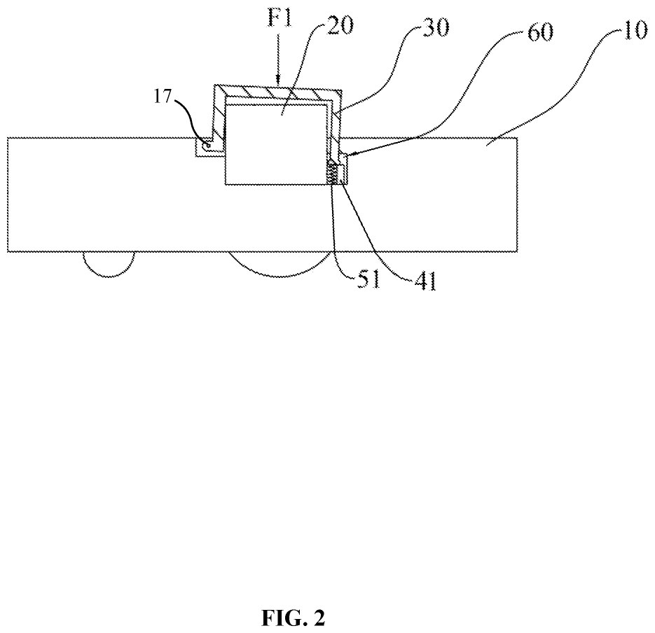

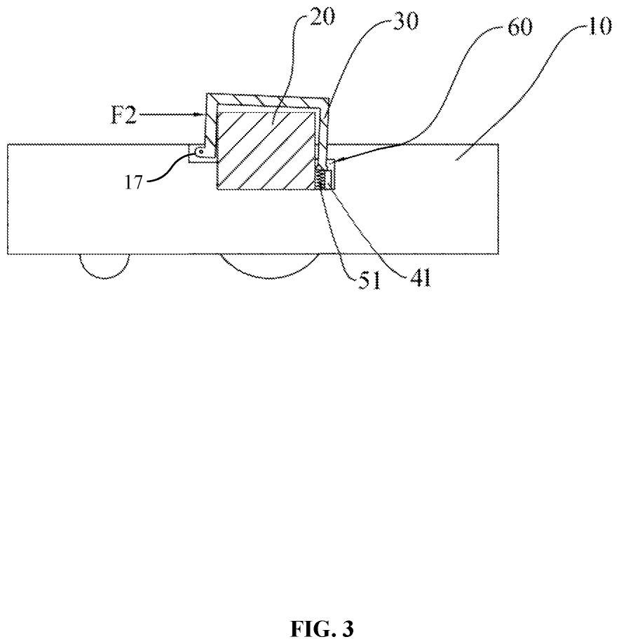

FIG. 1 is a schematic illustration of an initial state of an autonomous mobile device 5 provided by a first embodiment of the present disclosure; FIG. 2 is a first schematic illustration of the autonomous mobile device 5 provided by the first embodiment; FIG. 3 is a second schematic illustration of the autonomous mobile device 5 provided by the first embodiment.

As shown in FIG. 1 to FIG. 3, the autonomous mobile device 5 may include a main body 10, a protruding element 20, a protection cover 30, a detecting device, a position restoring assembly and a processor 19 (only shown in FIG. 1 for illustrative purposes).

The autonomous mobile device 5 includes the main body 10. The autonomous mobile device 5 typically performs certain tasks. For example, when the autonomous mobile device 5 is a smart cleaning robot, the task may be cleaning the floor. The autonomous mobile device 5 may also include a motion device configured to move the main body 10 on the floor. A positive moving direction may be defined as a moving direction of the main body 10 when the main body 10 is driven by the motion device to normally perform a task (the direction indicated by the arrow in FIG. 1 is the positive moving direction of the main body 10). The main body 10 is illustratively shown as having a cylindrical overall shape. The motion device may include an omni-direction wheel mounted at a front bottom portion of the main body 10 in the positive moving direction and driving wheels symmetrically disposed at two sides of a central axis of the bottom portion of the main body 10 of the autonomous mobile device 5. The main body 10 may also include a working apparatus. For example, for a cleaning robot, the working apparatus may include a cleaning apparatus mounted at the bottom portion of the main body 10 of the cleaning robot.

The present disclosure does not limit the motion device disposed on the main body 10, the configuration and location of the working apparatus. The motion device may include track type motion mechanisms that are arranged in parallel, or dual-legged/multi-legged walking mechanisms. The working apparatus may be disposed at a suitable location depending on the functionality.

The protruding element 20 protrudes from a top portion of the main body 10. The protruding element 20 may be detachably mounted to the main body 10. For example, in order to provide certain specific functions, the protruding element may be formed by elements such as a camera, a sensor, which are disposed at the top portion of the main body 10 and which protrude from the top portion. The protruding element 20 may also be integrally formed with the main body 10 to form a single structure. For example, in order to accommodate mechanical or electrical elements disposed inside the main body 10, an accommodation structure may be disposed at the top portion of the main body and the accommodation structure may protrude from the top portion. In this embodiment, the protruding element 20 may be a Lidar device disposed at the top portion of the main body 10, or may also include parts for housing or fixing the Lidar device. During an operation of the autonomous mobile device 5, the Lidar device may scan the surrounding environment to provide distance/location information of objects in the environment for localization and mapping for the autonomous mobile device 5, thereby providing data support for reasonable and efficient route planning.

The protection cover 30 may be disposed at an outer side of the protruding element 20 to cover the protruding element 20, and may be movable relative to the main body 10. The protection cover 30 may be movably connected with the main body 10, and/or may be movably connected with the protruding element 20. The term “movably connected” or “movable connection” in the present disclosure means that two objects movably connected together may restrict one another, may at least roughly define the relative locations of the two objects, and may experience relative movement or rotation to a certain extent. When the protection cover 30 is not experiencing a collision, the protection cover 30 is at an initial location. When the protection cover 30 is collided by an external force, the protection cover 30 experiences a displacement to move away from the initial location. The detecting device may detect the displacement of the protection cover 30 to determine whether the protection cover 30 collides with an obstacle in the environment. In some embodiments, there may be a gap between the protection cover 30 and the protruding element 20, such that when the protection cover 30 moves due to the collision, contact between the inner surface of the protection cover 30 and the protruding element 20 may be avoided. For example, when the protruding element 20 is a Lidar device, the protection cover 30 may include a top plate disposed over the Lidar device and multiple supporting pillars connected to a lower surface of the top plate. Two adjacent supporting pillars may be spaced apart with an empty space formed therebetween, which reduces blockage of the protection cover 30 to the emitted light and received light of the Lidar device. The present disclosure does not limit the material and the structure of the protection cover 30.

Various types of connections may be used to movably connect the protection cover 30 and the main body 10 or the protruding element 20. For example, the main body 10 or the protruding element 20 may be provided with a sliding groove extending in the positive moving direction. The protection cover 30 may be slidably mounted on the sliding groove. When the protection cover 30 experiences a collision, the protection cover 30 may slide along the sliding groove.

The detecting device may include a mileage switch, a micro-motion switch, a photoelectric switch or an optocoupler switch, as long as the detecting device can sense the displacement of the protection cover 30. The detecting device may be electrically connected with the processor, and may transmit displacement information to the processor, such that the processor may calculate the next action based on the displacement information. For example, the detecting device may be a mileage switch. When the protection cover 30 moves, the protection cover 30 may press the mileage switch, such that the mileage switch may change an operating state, and may transmit state information to the processor.

The position restoring assembly may be connected with the protection cover 30. After the protection cover 30 experiences a displacement caused by the external force, and after the external force is released, the position restoring assembly may be configured to restore the protection cover to a location when the protection cover 30 is free from the external force, such that the protection cover 30 and the detecting device can perform next detection.

In some embodiments, the detecting device may include a force sensor configured to directly detect the external force exerted on the protection cover 30, and to transmit force information to the processor.

In the autonomous mobile device provided by the embodiment of the present disclosure, the protruding element 20 is disposed at the top portion of the main body 10. The protection cover 30 is disposed at the outer side of the protruding element 20 to cover the protruding element 20. The protection cover 30 is movably connected with the main body 10 or the protruding element 20. The detecting device is configured to detect an external force exerted on the protection cover 30 or a displacement experienced by the protection cover 30 caused by the external force. The detecting device may transmit information of the external force or displacement to a processor. As such, by disposing the protection cover 30 at the outer side of the protruding element 20 to cover the protruding element 20, the protruding element 20 is protected from collision, thereby reducing the chance of damaging the protruding element 20. In addition, the protection cover 30 is movably connected with the main body 10 and/or the protruding element 20. The protection cover 30 may move under an external force. The detecting device may determine whether the protection cover 30 is experiencing a collision by detecting whether there is a displacement of the protection cover 30. The autonomous mobile device may take the next action based on the detecting result, making the autonomous mobile device more intelligent. After the protection cover experiences a displacement caused by the external force, and after the external force is released, the position restoring assembly may restore the protection cover 30 to a position where the protection cover 30 is free from the external force. Thus, a reserved gap between the protection cover 30 and the protruding element 20 is maintained after the external force on the protection cover 30 is released, such that the detecting device is not triggered, and is ready for the next detection in the meantime.

The position restoring assembly may be disposed between the protruding element 20 and the protection cover 30. For example, the position restoring assembly may include a position restoring spring disposed between the protruding element 20 and the protection cover 30. A first end of the position restoring spring may abut against a bottom portion of the protection cover 30, and a second end of the position restoring spring may abut against a top portion or a bottom portion of the protruding element 20. In some embodiments, the position restoring assembly may be disposed between the protection cover 30 and the main body 10. For example, in the embodiment in which the protection cover 30 is slidably disposed on a sliding groove on the main body 10, the position restoring assembly may include a position restoring spring having a first end connected with the protection cover 30, and a second end connected with a sliding groove. As such, on one hand, the protection cover 30 may be driven by the position restoring assembly to return to its initial position (a position where the protection cover 30 is free from the external force. As such, the protection cover 30 and the detecting device can prepare for the next detection. On the other hand, if when driven by the position restoring assembly, the protection cover 30 still has not returned to its initial position, it indicates that the external force exerted on the protection cover 30 has not been released (for example, when the autonomous mobile device is jammed and has not escaped from the predicament). Therefore, the autonomous mobile device may determine whether the external force on the protection cover 30 has been released by detecting, through the detecting device, whether the protection cover 30 has been restored to its initial position.

It is understood that the position restoring assembly may include any other suitable elements, such as an elastic plate, a rubber band, a set of two magnets having the same poles facing each other, as long as the element can drive the protection cover 30 to return to its initial position.

In some embodiments, an extension-retraction groove 60 may be disposed on the main body 10 along a circumference of a lower side of the protruding element 20. The protection cover 30 may be disposed in the extension-retraction groove 60. The circumference may be the entire circle or a portion of the circle. As such, the structure of the autonomous mobile device may be more compact. Illustratively, as shown in FIG. 1 to FIG. 4, the protruding element 20 may include a cylindrical structure. The extension-retraction groove 60 may be formed on the top portion of the main body 10 along the circumference of the lower side of the protruding element 20. A lower end of the protection cover 30 may be inserted into the circular extension-retraction groove 60. It is understood that the extension-retraction groove 60 may be other shapes, such as rectangular, square, oval shapes, etc. In some embodiments, the extension-retraction groove 60 may be an arc segment, or several spaced-apart arc segments at the connection interface between the main body 10 and the protruding element 20.

In some embodiments, the two ends of the position restoring assembly may be connected with the protection cover 30 and the groove bottom of the extension-retraction groove 60, respectively. A first end of the detecting device may be connected with the groove bottom of the extension-retraction groove 60, a second end of the detecting device may contact the lower portion of the protection cover 30 when the protection cover 30 is subject to the external force or is experiencing a displacement caused by the external force.

In some embodiments, as shown in FIG. 1, a front end of the protection cover along the positive moving direction may be connected with the main body 10 or the protruding element 20, such that the protection cover 30 may rotate upwardly and downwardly around the front end of the protection cover. A rotation axis 17 of the rotation may be parallel with the horizontal plane, and perpendicular to the positive moving direction of the main body 10. When the autonomous mobile device moves along the positive moving direction, collision between the protection cover 30 and the obstacles in the environment usually occurs at the top portion of the protection cover 30 and/or in front of the positive moving direction. That is, the pressing force exerted on the top portion of the protection cover 30 is a force F1 as shown in FIG. 2, and/or a force in the opposite direction of the positive moving direction such as the force F2 shown in FIG. 3. Here a force in the opposite direction of the positive moving direction means that the direction of the force is against the positive moving direction. The rotation axis of the protection cover 30 is parallel with the horizontal plane and perpendicular to the positive moving direction, such that when the protection cover 30 is subject to the external force F1 or F2, the protection cover 30 can rotate, and the detecting device can detect the external force F1 or F2, or the displacement caused by the external force F1 or F2. The above external force F1, F2 are only the force components in the corresponding directions.

In some embodiments, the detecting device may include a first detecting device 41, the position restoring assembly may include a first position restoring assembly 51. A first end of the first position restoring assembly 51 may be connected with a groove bottom at a back end of the extension-retraction groove 60 along the positive moving direction. A second end of the first position restoring assembly 51 may be connected with a lower portion of the back end of the protection cover along the positive moving direction. A first end of the first detecting device 41 may be connected with the groove bottom at the back end of the extension-retraction groove 60 along the positive moving direction. A second end of the first detecting device may contact the lower portion of the back end of the protection cover 30 along the positive moving direction when the protection cover 30 rotates downwardly. When the back end of the protection cover 30 along the positive moving direction moves downwardly as the protection cover rotates downwardly caused by the external force, the first detecting device 41 may contact the protection cover 30, thereby detecting the displacement of the protection cover 30. In addition, the first position restoring assembly 51 disposed in the extension-retraction groove 60 located at the back portion of the main body 10 (relative to the positive moving direction) may restore the position of the back end of the protection cover 30. It is understood that another extension-retraction groove may be disposed at the front portion of the main body (relative to the positive moving direction), and a detecting device and a position restoring assembly may be similarly disposed in the extension-retraction groove.

In some embodiments, illustratively, the first position restoring assembly 51 may include a spring. The spring may be disposed in the extension-retraction groove 60 along a direction perpendicular to the main body 10. An upper end of the spring may be connected with the protection cover 30. A lower end of the spring may be connected with the extension-retraction groove 60. Alternatively, the first position restoring assembly 51 may include a cylindrical body formed by rubber or an elastic plate fabricated using an elastic steel, which can also realize the function of restoring, after the external force is released, the protection cover 30 to a position where the protection cover 30 is free from the external force. In addition, the number and location of the first detecting device 41 are not limited. In some embodiments, the first detecting device 41 may be disposed between the protruding element 20 and the protection cover 30, for example, between the top surface at a middle portion of the protruding element 20 and a bottom surface at a middle portion of the protection cover 30, or between an outer side surface of the protruding element 20 and an inner surface of the protection cover 30 at a corresponding location. It is understood that in some embodiments, there may be multiple first detecting devices 41.

In some embodiments, a front end of the protection cover 30 may be hinge-connected to the main body 10 or the protruding element 20 through a rotating shaft. Hinge-connection through a rotating shaft may include connecting the protection cover 30 and the main body 10 or the protruding element 20 through a rotating shaft, such that the protection cover 30 may rotate relative to the main body 10 or the protruding element 20. Hinge-connection may also include: two or more supporting points are provided between the main body 10 and the protection cover 30, or between the protruding element 20 and the protection cover 30. Connecting the two or more supporting points forms a rotating axis. The protection cover 30 can rotate around the rotating axis relative to the main body 10 or the protruding element 20. For example, two ball-shaped protrusions may be disposed facing each other on a side wall of the protruding element 20 along a direction that is parallel with a top surface of the main body 10 and perpendicular to the positive moving direction. Two ball-shaped concave grooves may be disposed on the protection cover 30 at corresponding locations. The ball-shaped protrusions may fit into the ball-shaped concave grooves, such that the protection cover 30 may rotate around a connection between two ball-shaped protrusions. As such, the moving trajectory of the protection cover 30 is more controllable. In addition, the connection between the protection cover 30 and the main body 10 or the protruding element 20 is more secure.

Illustratively, as shown in FIG. 1, the front end of the protection cover 30 may be hinge-connected with the main body 10 through a rotating shaft. The first position restoring assembly 51 and the first detecting device 41 may be disposed between a back end of the protection cover 30 and the extension-retraction groove 60. As shown in FIG. 2, when the protection cover 30 is subject to a pressing force from above, such as the force F1 as shown in FIG. 2, the protection cover 30 may rotate clock-wise around the rotation shaft to compress the first position restoring assembly 51, and may contact the first detecting device 41. As shown in FIG. 3, when the protection cover 30 is subject to a force in a direction opposite to the positive moving direction such as F2 shown in the figure, the protection cover 30 may rotate clock-wise around the rotation shaft to compress the first position restoring assembly 51 and may contact the first detecting device 41. The above external forces F1 and F2 are only component forces in corresponding directions.

### Second Embodiment

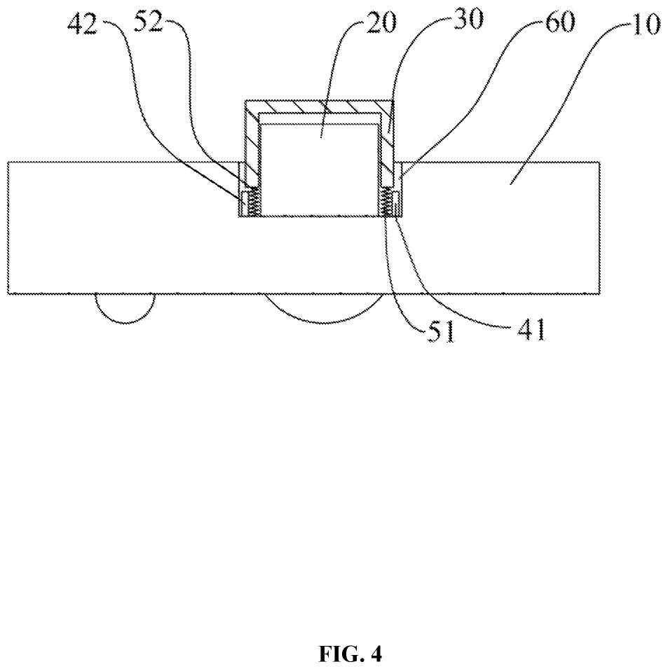

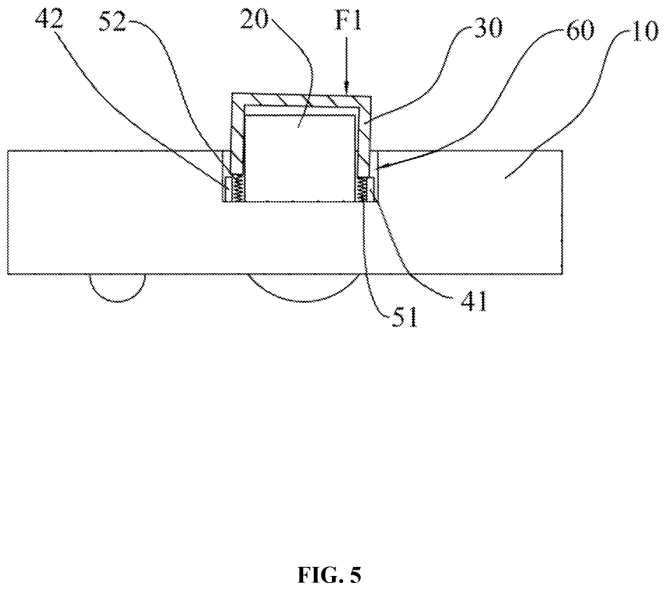

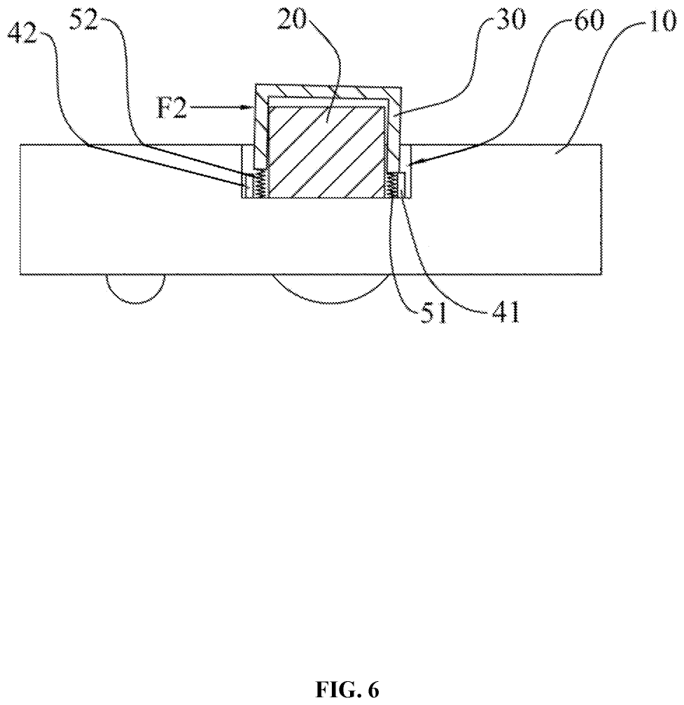

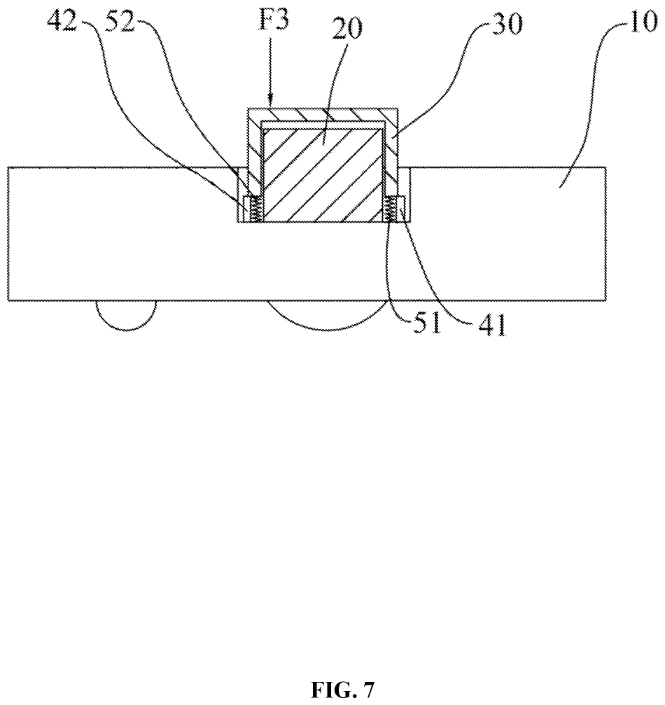

FIG. 4 is a schematic illustration of an initial state (a state free from an external force) of the autonomous mobile device provided by a second embodiment of the present disclosure. FIG. 5 is a first schematic illustration of the autonomous mobile device provided by the second embodiment. FIG. 6 is a second schematic illustration of the autonomous mobile device provided by the second embodiment. FIG. 7 is a third schematic illustration of the autonomous mobile device provided by the second embodiment.

The embodiment shown in FIG. 4 to FIG. 7 is basically the same as the first embodiment. The first position restoring assembly and the first detecting device correspond to the first position restoring assembly and the first detecting device of the first embodiment. The differences lie in:

The detecting device also includes a second detecting device 42, and the position restoring assembly also includes a second position restoring assembly 52. A first end of the second position restoring assembly 52 may be connected with the groove bottom at the front end of the extension-retraction groove 60 along the positive moving direction. A second end of the second position restoring assembly 52 may be connected with the lower portion of the front end of the protection cover 30 along the positive moving direction. A first end of the second detecting device 42 may be connected with the groove bottom at the front end of the extension-retraction groove 60 along the positive moving direction. The second end of the second detecting device 42 may contact the lower portion of the front end of the protection cover 30 along the positive moving direction when the protection cover 30 rotates downwardly (relative to the back part of the moving direction) or when the protection cover moves (relative to the front part of the moving direction).

Illustratively, as shown in FIG. 4 to FIG. 7, the second position restoring assembly 52 may include a spring. The spring may be disposed in the extension-retraction groove 60 in a direction perpendicular to the main body 10. An upper end of the spring may be connected with the protection cover 30, and a lower end of the spring may be connected with the extension-retraction groove 60. The detecting device may be disposed in the extension-retraction groove 60, and between the protection cover 30 and the main body 10 and/or the protruding element 20, such as, at the groove bottom or side surface of the extension-retraction groove 60. The detecting device may include, along the positive moving direction, the second detecting device 42 disposed at the front and the first detecting device 41 disposed at the back. As shown in FIG. 5, when the protection cover 30 is subject to a pressing force exerted from above the protection cover 30, such as the force F1 shown in the figure, the protection cover 30 may rotate along with the spring in the clock-wise direction, such that the back end of the protection cover 30 may abut against the first detecting device 41, thereby enabling the first detecting device 41 to detect the collision occurring to the protection cover. As shown in FIG. 6, when the protection cover 30 is subject to a force in the opposite direction of the positive moving direction such as the force F2 shown in the figure, the protection cover 30 may rotate along with the spring in the clock-wise direction, such that the back end of the protection cover 30 may abut against the first detecting device 41, thereby enabling the first detecting device 41 to detect the collision occurring to the protection cover 30. As shown in FIG. 7, when the protection cover 30 is subject to a pressing force exerted from above the protection cover 30 and on a front portion (in the moving direction) of the protection cover 30 such as the force F3 shown in the figure, the protection cover 30 may compress the spring and move toward the extension-retraction groove 60, such that the protection cover 30 may abut against the second detecting device 42 and the first detecting device 41, thereby enabling both of the second detecting device 42 and the first detecting device 41 to detect the collision occurring to the protection cover 30. Alternatively, the protection cover 30 may rotate along with the spring in the counter-clock wise direction, such that the front end of the protection cover 30 may abut against the second detecting device 42, thereby enabling the second detecting device 42 to detect the collision occurring to the protection cover 30.

The second position restoring assembly 52 may be a cylindrical pillar made of rubber or an elastic plate made of an elastic steel, which may also realize the rotation of the protection cover 30. In addition, the quantity and positions of the second detecting device are not limited. The second detecting device 42 may also be disposed between the protruding element 20 and the protection cover 30, for example, between an outer side surface of the protruding element 20 along the positive moving direction and an inner surface of the protection cover 30 at corresponding locations. It is understood that in some embodiments, there may be multiple second detecting devices 42.

In the autonomous mobile device provided by this embodiment of the present disclosure, the protruding element 20 is disposed at the top portion of the main body 10, the protection cover 30 is provided at an outer side of the protruding element 20 and covers the protruding element 20. The protection cover 30 may be movably connected with the main body 10 or the protruding element 20. The detecting device may be configured to detect the external force exerted on the protection cover 30 or the displacement experienced by the protection cover 30 caused by the external force, and may transmit information of the external force or the displacement to the processor. As such, the protection cover 30 disposed at the outer side of the protruding element 20 may protect the protruding element 20 from collision, thereby reducing the chance of damaging the protruding element 20. In addition, because the protection cover 30 is movably connected with the main body 10 and/or the protruding element 20, when the protection cover 30 experiences a displacement caused by the external force, the detecting device may determine whether a collision occurs to the protection cover 30 by detecting the displacement of the protection cover 30. Therefore, the autonomous mobile device may take the next action based on the detection result, which makes the autonomous mobile device more intelligent. In addition, after the protection cover 30 experiences the displacement caused by the external force and after the external force is released, the position restoring assembly may restore the protection cover to a position where the protection cover 30 is free from the external force. As such, after the external force is released, a reserved gap between the protection cover 30 and the protruding element 20 is maintained, such that the detecting device is no longer triggered, and is ready for the next detection.

### Third Embodiment

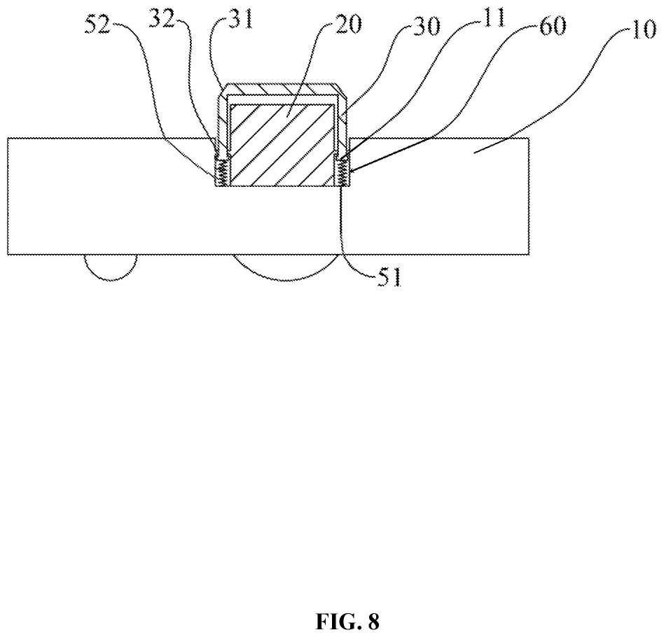

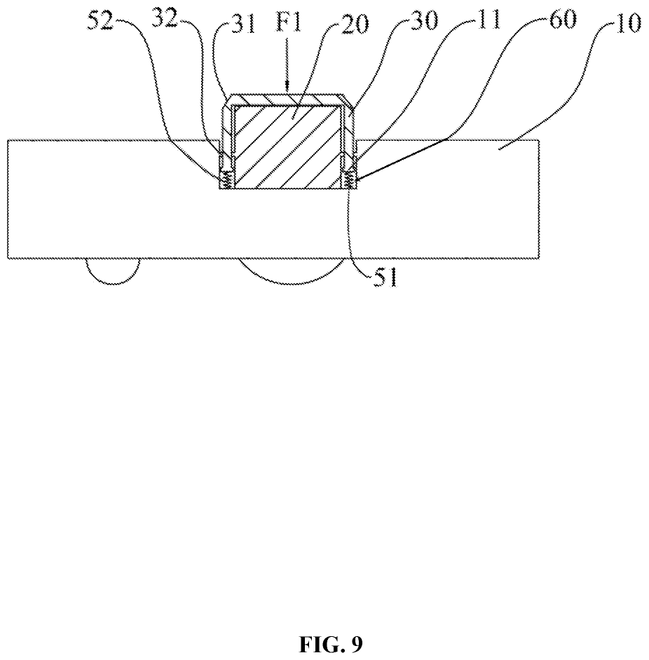

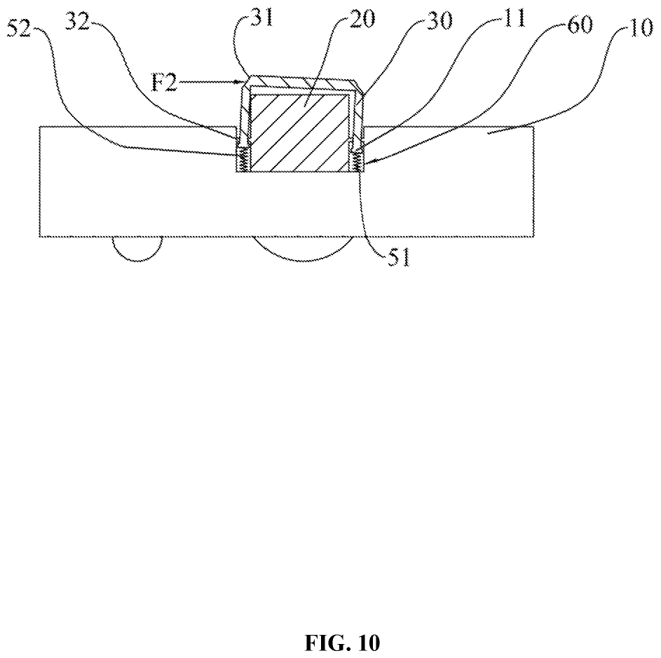

FIG. 8 is a schematic illustration of an initial state (a state free from an external force) of an autonomous mobile device provided by the third embodiment of the present disclosure. FIG. 9 is a first schematic illustration of the autonomous mobile device provided by the third embodiment of the present disclosure. FIG. 10 is a second schematic illustration of the autonomous mobile device provided by the third embodiment of the present disclosure.

This embodiment is basically the same as the first embodiment or the second embodiment. The differences lie in:

While being able to rotate, the protection cover 30 may also be slidably disposed in the extension-retraction groove 60 in a direction substantially perpendicular to the positive moving direction of the main body 10. The direction substantially perpendicular to the positive moving direction is a direction forming an angle in a range of about 80°-100° relative to the positive moving direction of the main body 10. As such, the protection cover 30 can not only swing around the rotation shaft or axis, but also move in the direction perpendicular to the main body 10. Thus, the style of motion of the protection cover 30 is diverse, which makes the detection of the protection cover 30 by the detecting device more accurate.

Multiple types of connections may be used between the protection cover 30 and the main body 10 or the protruding element 20. Illustratively, as shown in FIG. 8, the protection cover 30 may be slidably disposed in the extension-retraction groove 60 in a direction that is substantially perpendicular to the positive moving direction of the main body 10. The direction substantially perpendicular to the positive moving direction is a direction forming an angle in a range of about 80°-100° relative to the positive moving direction of the main body 10. Position restoring assemblies are disposed between the front end of the protection cover 30 and the extension-retraction groove 60 and between the back end of the protection cover 30 and the extension-retraction groove 60. The front end of the protection cover 30 is provided with the second position restoring assembly 52. The back end of the protection cover 30 is provided with the first position restoring assembly 51. The thickness of a wall of the protection cover 30 inserted into the extension-retraction groove 60 is smaller than the width of the extension-retraction groove 60, such that the protection cover 30 can rotate in a certain extent within the extension-retraction groove 60. As shown in FIG. 9, when the protection cover 30 is subject to a pressing force exerted from above such as the force F1 shown in the figure, the protection cover 30 may move toward the extension-retraction groove 60 in a direction perpendicular to the main body 10, and may compress the first position restoring assembly 51 and the second position restoring assembly 52. As shown in FIG. 10, when the protection cover 30 is subject to a force in a direction opposite to the positive moving direction such as the force F2 shown in the figure, the protection cover 30 may rotate clock-wise as illustrated, and the back end of the protection cover 30 may compress the first position restoring assembly 51. In some embodiments, a slant surface 31 may be configured at the front end of the protection cover 30. When the force F2 is exerted on the slanted surface 31, a component force of the force F2 may be generated in the direction perpendicular to the slanted surface 31, and this component force may point toward the extension-retraction groove 60. When the protection cover 30 is subject to this component force, it is easier for the back end of the protection cover 30 to move toward the extension-retraction groove 60.

It is understood that in some embodiments, there may be multiple first position restoring assemblies 51 and/or second position restoring assemblies 52.

In some embodiments, a first position restricting ring 11 may be disposed at a location of the protection cover 30 facing the bottom of the extension-retraction groove, and a second position restricting ring 32 may be disposed at a side wall of the extension-retraction groove 60. The second position restricting ring 32 may be configured to block the first position restricting ring 11 from moving out of the extension-retraction groove 60. As such, the protection cover 30 is protected from derailing out of the extension-retraction groove 60 when driven by the position restoring assembly. In some embodiments, a position restricting protrusion may be disposed at an outer wall of the protection cover 30, and a position restricting concave groove may be disposed at a side wall of the extension-retraction groove 60. When the protection cover 30 moves toward the outside of the extension-retraction groove 60 to a certain position, the position restricting protrusion may insert into the position restricting concave groove, thereby blocking the protection cover 30 from continuing to move toward the outside of the extension-restriction groove 60.

In some embodiments, multiple position restoring assemblies may be disposed at intervals surrounding a central line of the extension-retraction groove 60. A first end of each position restoring assembly may be connected with the first position restricting ring 11. As such, when the protection cover 30 experiences a collision, the supporting forces provided by the multiple position restoring assemblies may be more even.

Other types of connections may be used to connect the protection cover 30 and the main body 10 or the protruding element 20. For example, a base may be disposed within the extension-retraction groove 60. A lower end of the base may be connected with the groove bottom of the extension-retraction groove 60 through a spring. A front end of the protection cover 30 may be hinge-connected onto the base. As such, when the top portion of the protection cover 30 is subject to a force, the protection cover 30 may rotate around a hinge connection point between the protection cover 30 and the base.

In the autonomous mobile device provided by this embodiment of the present disclosure, the protruding element 20 may be disposed at the top portion of the main body 10. The protection cover 30 may be disposed at an outer side of the protruding element 20 to cover the protruding element 20. The protection cover 30 may be movably connected with the main body 10 or the protruding element 20. The detecting device is configured to detect the external force exerted on the protection cover 30 or the displacement of the protection cover 30 caused by the external force, and to transmit information of the external force or the displacement to the processor. As such, the protection cover 30 provided at the outer side of the protruding element 20 may protect the protruding element 20 from collision, thereby reducing the chance of damaging the protruding element 20. In addition, the protection cover 30 may be movably connected with the main body 10 and/or the protruding element 20. The protection cover 30 can move when the protection cover is subject to the external force, such that the detecting device may determine whether the protection cover 30 is experiencing a collision by detecting the displacement of the protection cover 30. Therefore, the autonomous mobile device may take the next action based on the detection result, making the autonomous mobile device more intelligent. In addition, after the protection cover 30 experiences a displacement caused by the external force and after the external force is released, the position restoring assembly may restore the protection cover to a position where the protection cover 30 is free from the external force. As such, after the external force is released, a reserved gap between the protection cover 30 and the protruding element 20 may be maintained, such that the detecting device is no longer triggered, and is ready for the next detection.

### Fourth Embodiment

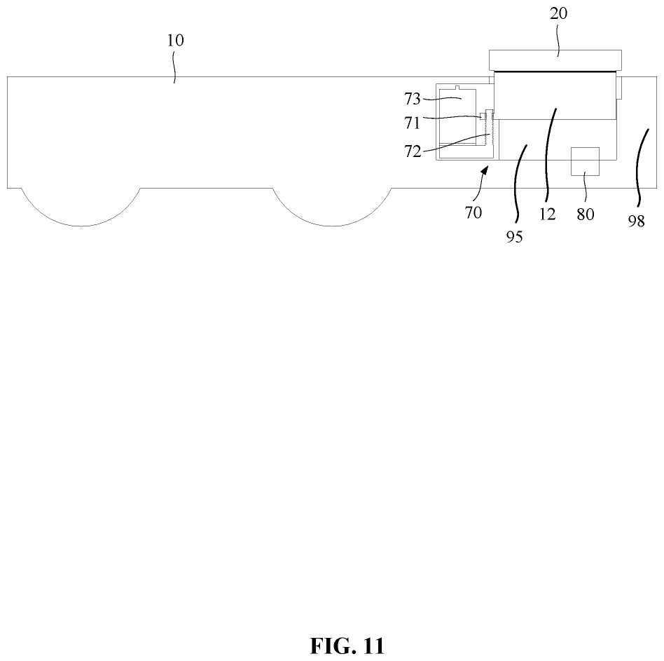

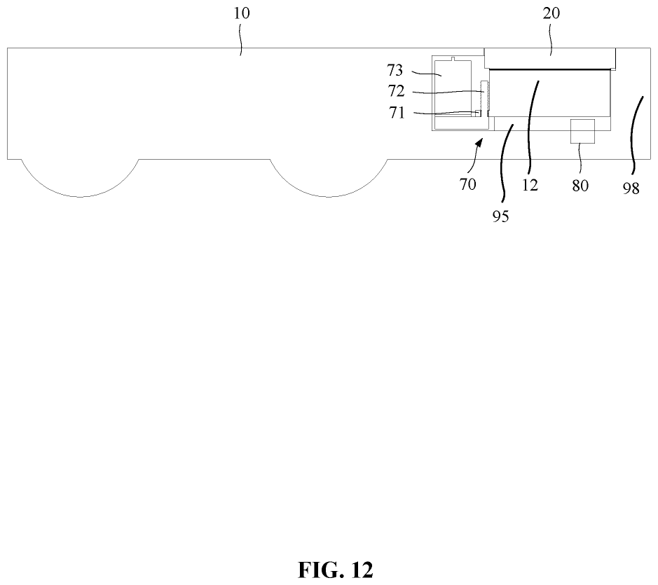

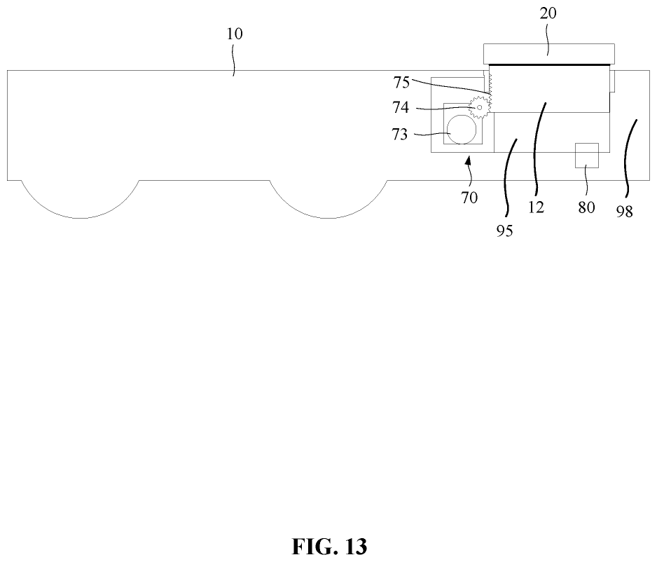

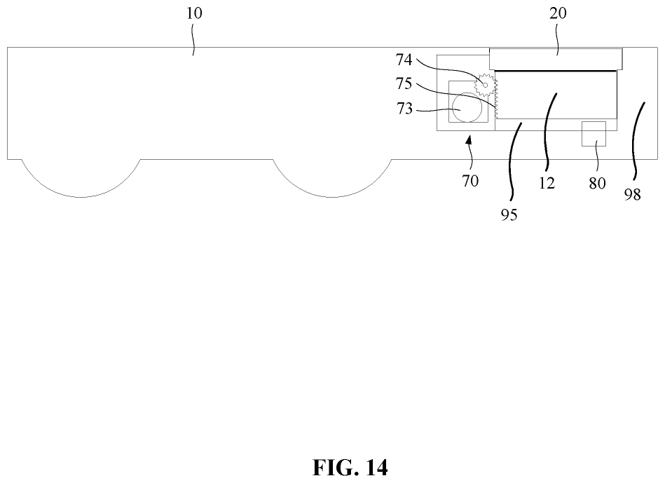

FIG. 11 is a schematic illustration of an initial state (a state free from an external force) of an autonomous mobile device provided by the fourth embodiment of the present disclosure. FIG. 12 is a schematic illustration of the autonomous mobile device shown in FIG. 11 when the protruding element is retracted. FIG. 13 is a schematic illustration of an initial state (a state free from an external force) of another autonomous mobile device provided by the fourth embodiment of the present disclosure. FIG. 14 is a schematic illustration of the autonomous mobile device shown in FIG. 13 when the protruding element is retracted.

This embodiment is basically the same as the first embodiment, the second embodiment, or the third embodiment. The differences lie in:

As shown in FIG. 11 to FIG. 14, in this embodiment, the protruding element 20 may be detachably mounted to the main body 10. The main body 10 may include a frame 98 and a fixing part 12. An elevation channel 95 may be provided within the frame 98. The fixing part 12 may be slidably disposed inside the elevation channel 95. The protruding element 20 and the protection cover 30 may be disposed on the fixing part 12. An elevation device 70 may be connected with the frame 98 and the fixing part 12, such that the protruding element 20 and the protection cover 30 can extend out of or retract back into the elevation channel 95 when driven by the elevation device 70.

Because the protruding element 20 and the protection cover 30 may extend out of or retract back into the elevation channel 95, when the protection cover 30 is collided (for example, when the protection cover 30 is jammed by a hollow-lower-portion type obstacle), the autonomous mobile device may escape the predicament by lowering and retracting the protruding element 20 and the protection cover 30 into the elevation channel 95.

It is understood that the height of the protruding element that is above the top surface of the main body 10 is smaller than or equal to ½ of the height of the main body 10, which may avoid the situation of the protruding element 20 falling out of the elevation channel 95.

It is understood that during the process of a normal operation of the autonomous mobile device, the protection cover 30 and the protruding element 20 are maintained at the upper limit positions, i.e., the highest positions. When the protection cover 30 is experiencing a collision, the elevation device 70 may take actions, such that the protection cover 30 and the protruding element 20 may be lowered to the lower limit positions in the elevation channel 95. Correspondingly, the protection cover 30 fully enters into the elevation channel 95, such that the autonomous mobile device can escape the predicament. After the autonomous mobile device escapes the predicament, the elevation device 70 may move the protection cover 30 and the protruding element 20 back to the upper limit positions, such that the protruding element 20 can perform normal operations.

The elevation device 70 may be realized using multiple implementations. As one of the implementations, the elevation device 70 may be realized using a screw pair.

Illustratively, as shown in FIG. 11 and FIG. 12, the elevation device 70 may include a driving nut 71, a driving screw 72, and a rotation device 73. The driving nut 71, the driving screw 72, and the rotation device 73 are all within the elevation channel 95. The driving screw 72 may extend in the depth direction of the elevation channel 95. The driving nut 71 may be fixed to a side wall of the fixing part 12. The driving screw 72 may be rotatably connected with the frame 98. The driving nut 71 and the driving screw 72 match with one another. The rotation device 73 and the driving screw 72 may be transmissively connected to cause the driving screw 72 to rotate, such that the driving nut 71 and the fixing part 12 together move in an extension direction of the driving screw 72, thereby enabling the protruding element 20 and the protection cover 30 to extend out of or retract back into the elevation channel 95. By realizing the ascending and descending of the fixing part through the screw pair, the control may become more accurate.

The elevation device 70 may also include a guiding element. The guiding element may be the side wall of the elevation channel 95. For example, the inner profile of the side wall of the elevation channel 95 may match with the outer profile of the fixing part 12, such that the fixing part 12 may ascend and descend along the side wall of the elevation channel 95.

The rotation device 73 may include an electric motor, two belt pulleys, a belt (or a chain, a chain wheel), etc. For example, a shaft of the electric motor may be connected with a belt pulley, and another belt pulley may be fixed onto the external surface of the driving screw 72. The belt may wrap around the two belt pulley and extend tightly between the two belt pulleys. As such, when the electric motor drives one belt pulley, the one belt pulley may drive the other belt pulley to rotate. The driving screw 72 may rotate when driven by the belt pulleys, such that the fixing part 12 may ascend or descend when driven by the driving nut 71.

As shown in FIG. 13 and FIG. 14, as another implementation, the elevation device 70 may be realized through pinion and rack pair. Illustratively, as shown in the figures, the elevation device 70 may include a driving pinion 74, a rack 75, and the rotation device 73. The rack 75 may be connected with the fixing part 12, and may extend in the depth direction of the elevation channel 95. The driving pinion 74 may be engaged with the rack 75. The rotation device 73 and the driving pinion 74 may be transmissively connected to cause the driving pinion 74 to rotate.

The rack 75 may be fixed to the side wall of the fixing part 12. The rotation device 73 may include an electric motor and a deceleration box, etc. A main shaft of the electric motor and an input end of the deceleration box may be transmissively connected. The driving pinion 74 and the output end of the deceleration box may be transmissively connected, such that the deceleration box may adjust the rotation speed and torque of the driving pinion 74.

In some embodiments, the elevation device 70 may include an encoder. The encoder may be configured to detect the rotation angle of the main shaft of the electric motor, thereby determining the position of the fixing part 12 in the elevation channel 95 by controlling the rotation angle.

In this embodiment, a detecting apparatus may include a photoelectric sensor or a micro-motion switch disposed at the bottom of the elevation channel 95. The technology for the photoelectric sensor or the micro-motion switch is mature, and the detection is more accurate.

Further, the autonomous mobile device may include a detecting apparatus 80 (shown in FIG. 11). The detecting apparatus 80 may be configured to detect a position of the fixing part 12 in the elevation channel 95. For example, the detecting apparatus 80 may be disposed inside the elevation channel 95, such as the groove bottom of the elevation channel 95, and may be configured to detect the position of the fixing part 12 in the elevation channel 95. By configuring the detecting apparatus 80, when the fixing part 12 is at the groove bottom of the elevation channel 95, the operation of the elevation device 70 may be stopped. In addition, the location of the detecting apparatus 80 may be any other suitable location in the main body, such as inside the main body, at a location adjacent the elevation channel 95, which is not limited in the present disclosure.

The detecting apparatus 80 may also be configured to detect whether a top portion of the protection cover 30 is located at notch of the elevation channel 95. That is, when the protection cover 30 is fully located inside the elevation channel 95, the autonomous mobile device may continue to move forwardly, or may move backwardly, make turns, etc., to retract from the space below the hollow-lower-portion type of obstacle.

In the autonomous mobile device provided by this embodiment of the present disclosure, the protruding element 20 may be disposed at the top portion of the main body 10. The protection cover 30 may be disposed at the outer side of the protruding element 20 to cover the protruding element 20. The protection cover 30 may be movably connected with the main body 10 or the protruding element 20. The detecting device may be configured to detect the external force exerted on the protection cover or the displacement experienced by the protection cover caused by the external force, and may transmit information of the external force or the displacement to the processor. As such, the protection cover 30 disposed at the outer side of the protruding element 20 may protect the protruding element 20 from collision, thereby reducing the chance of damaging the protruding element. In addition, the protection cover 30 may be movably connected with the main body 10 and/or the protruding element 20. When the protection cover 30 experiences a displacement caused by the external force, the detecting device may determine whether the protection cover 30 is experiencing a collision through detecting the displacement of the protection cover 30. Accordingly, the autonomous mobile device may take the next action based on the detection result, making the autonomous mobile device more intelligent. In addition, after the protection cover 30 experiences a displacement caused by the external force and after the external force is released, the position restoring assembly may restore the protection cover 30 to a position where the protection cover 30 is free from the external force. As such, after the external force is released, a reserved gap between the protection cover 30 and the protruding element 20 may be maintained, such that the detecting device is no longer triggered, and is ready for next detection.

Finally, it is worth noting that: the above embodiments are only used to describe the technical solutions of the present disclosure, and are not intended to limit the scope of the present disclosure. Although the present disclosure has been described in detail with reference to the various embodiments, a person having ordinary skills in the art can appreciate: he/she can modify the technical solutions of the various embodiments, or can replace equivalent portions of some or all of the technical features. Such modification or replacement does not make the corresponding technical solutions fall out of the scope of the technical solutions of the embodiments of the present disclosure.

What is claimed is:

1. An autonomous mobile device, comprising:
a main body;
a protruding element disposed at a top portion of the main body;
a protection cover disposed at an outer side of the protruding element to cover the protruding element, the protection cover being movably connected with the main body or the protruding element;
a detecting device configured to detect an external force exerted on the protection cover or a displacement of the protection cover caused by the external force, and to transmit information of the external force or the displacement to a processor;
a position restoring assembly;
the processor; and
an extension-retraction groove disposed on the main body at a circumference of a lower portion of the protruding element,
wherein the protection cover is inserted into the extension-retraction groove,
wherein two ends of the position restoring assembly are connected with the protection cover and a groove bottom of the extension-retraction groove respectively,
wherein after the protection cover experiences the displacement caused by the external force and after the external force is released, the position restoring assembly is configured to restore the protection cover to a position where the protection cover is free from the external force,
wherein a first end of the detecting device is connected with the groove bottom of the extension-retraction groove, and a second end of the detecting device is configured to contact the protection cover when the protection cover is subject to the external force or is experiencing the displacement,
wherein a front end of the protection cover in a positive moving direction of the autonomous mobile device is connected with the main body or the protruding element, such that the protection cover is rotatable upwardly and downwardly around the front end of the protection cover, and a rotation axis of the upward and downward rotation is parallel with a horizontal plane and perpendicular to the positive moving direction,
wherein the detecting device includes a first detecting device and the position restoring assembly includes a first position restoring assembly,
wherein a first end of the first position restoring assembly is connected with the groove bottom at a back end of the extension-retraction groove along the positive moving direction, and a second end of the first position restoring assembly is connected with a lower portion of a back end of the protection cover along the positive moving direction,
wherein a first end of the first detecting device is connected with the groove bottom at the back end of the extension-retraction groove along the positive moving direction, and a second end of the first detecting device is configured to contact the lower portion of the back end of the protection cover along the positive moving direction when the protection cover rotates downwardly, and
wherein a front end of the protection cover is hinge-connected with the main body or the protruding element.

2. The autonomous mobile device of claim 1,
wherein the detecting device also includes a second detecting device, and the position restoring assembly also includes a second position restoring assembly,
wherein a first end of the second position restoring assembly is connected with the groove bottom at a front end of the extension-retraction groove along the positive moving direction, and a second end of the second position restoring assembly is connected with the lower portion of the front end of the protection cover along the positive moving direction, and
wherein a first end of the second detecting device is connected with the groove bottom at the front end of the extension-retraction groove along the positive moving direction, and a second end of the second detecting device is configured to contact the lower portion of the front end of the protection cover along the positive moving direction when the protection cover rotates downwardly.

3. The autonomous mobile device of claim 1,
wherein when the back end of the protection cover along the positive moving direction is subject to a downward pressing force that is perpendicular to a top portion of the protection cover, or when the front end of the protection cover along the positive moving direction is subject to a force in a direction opposite to the positive moving direction, the protection cover is configured to compress the first position restoring assembly and to contact the first detecting device.

4. The autonomous mobile device of claim 2,
wherein when the front end of the protection cover along the positive moving direction is subject to a force that is perpendicular to the top portion of the protection cover, the protection cover is configured to compress the second position restoring assembly and to contact the second detecting device.

5. The autonomous mobile device of claim 1,
wherein the protection cover is slidably disposed in the extension-retraction groove in a direction that is substantially perpendicular to the positive moving direction of the main body.

6. The autonomous mobile device of claim 1, further comprising:
a first position restricting ring disposed at a location of the protection cover facing the groove bottom of the extension-retraction groove; and a second position restricting ring disposed on a side wall of the extension-retraction groove,
wherein the second position restricting ring is configured to block the first position restricting ring from moving outside of the extension-restriction groove.

7. The autonomous mobile device of claim 5,
wherein the position restoring assembly includes multiple position restoring assemblies disposed at intervals surrounding a central axis of the extension-retraction groove, and
wherein each position restoring assembly is disposed in the extension-retraction groove, and an end of each position restoring assembly is connected with the first position restricting ring.

8. The autonomous mobile device of claim 1, further comprising an elevation device,
wherein the main body includes a frame and a fixing part,
wherein an elevation channel is disposed at a top portion of the frame,
wherein the fixing part is slidably disposed in the elevation channel, and
wherein the protruding element and the protection cover are disposed on the fixing part.

9. The autonomous mobile device of claim 8,
wherein the elevation device is connected with the frame and the fixing part, and is configured to control, when the detecting device detects a collision occurring to the protection cover, the fixing part to retract into the elevation channel, to thereby cause the protection cover and the protruding element to retract into the elevation channel.

10. The autonomous mobile device of claim 8,
wherein the elevation device includes a rotation device, a driving pinion and a rack,
wherein the rack is connected with the fixing part,
wherein the driving pinion and the rotation device are connected, and
wherein the driving pinion and the rack are engaged.

11. The autonomous mobile device of claim 10,
wherein the elevation device includes an encoder and a deceleration box,
wherein the rotation device includes an electric motor,
wherein a main shaft of the electric motor is connected with an input end of the deceleration box, and the driving pinion is connected with an output end of the deceleration box, and
wherein the encoder is configured to detect a rotation angle of the main shaft of the electric motor.

12. The autonomous mobile device of claim 10,
wherein the elevation device includes a driving nut, a driving screw, and the rotation device,
wherein the driving nut is connected with the fixing part,
wherein the driving screw is rotatably connected with the frame,
wherein the driving nut and the driving screw match with one another, and
wherein the rotation device and the driving screw are connected.

13. The autonomous mobile device of claim 8, further comprising a detecting apparatus configured to detect a location of the fixing part in the elevation channel.

14. The autonomous mobile device of claim 13, wherein the detecting apparatus includes a photoelectric sensor or a micro-motion sensor disposed at a bottom of the elevation channel.
